(19) United States
(12) Patent Application Publication
(10) Pub. No.: US 2026/0192869 A1
(43) Pub. Date: Jul. 9, 2026

(54) UNDERCOVER STRUCTURE

(71) Applicant: Honda Motor Co., Ltd., Tokyo (JP)

(72) Inventors: Hidefumi NIHEI, Tokyo (JP); Junichi SHIO, Tokyo (JP)

(73) Assignee: Honda Motor Co., Ltd., Tokyo (JP)

(21) Appl. No.: 19/438,641

(22) Filed: Jan. 1, 2026

(30) Foreign Application Priority Data
Jan. 3, 2025 (CN) 202510006869.5

(51) Int. Cl. B62D 35/02

(52) U.S. Cl. CPC B62D 35/02

(57) ABSTRACT

An undercover structure is provided. The undercover structure includes a cover body portion formed with a notch and a lid portion covering the notch and integrally formed with the cover body portion. The lid portion is connected to the cover body portion through a first hinge portion in an openable and closable manner. The lid portion includes a flange portion. The flange portion extends to a side closer to the cover body portion than an edge of the notch. When the lid portion is in a closed state, the flange portion is overlapped with and fixed onto the cover body portion in a thickness direction of the cover body portion.

### CROSS-REFERENCE TO RELATED APPLICATION

This application claims the priority benefit of China application serial no. 202510006869.5, filed on January 3, 2025. The entirety of the above-mentioned patent application is hereby incorporated by reference herein and made a part of this specification.

### BACKGROUND

### Technical Field

The disclosure relates to an undercover structure.

### Description of Related Art

In recent years, in order to ensure access to affordable, reliable, sustainable, and advanced energy for more people, research and development related to improving fuel efficiency, which contributes to energy efficiency, has been conducted.

In the prior art, Prior Art Document 1 (Japanese Utility Model Publication No. H04-84088) discloses an undercover. The undercover is provided with an opening, is formed of a resin material, and is formed with a lid body capable of opening and closing the opening and a thin wall portion serving as a hinge and disposed on a side portion of the opening. In Prior Art Document 1, two slits are provided from a front end side to a rear end side of the undercover, and the opening and the lid body are formed in a portion sandwiched between the two slits. Therefore, although the structure of Prior Art Document 1 allows maintenance work on a vehicle without removing the undercover through forming the lid body that may be opened and closed together with the hinge on the undercover, the structure of the slits disposed at the boundary between the lid body and the undercover as described in Prior Art Document 1 causes deterioration of aerodynamic performance, thereby affecting fuel efficiency. Furthermore, since the slits of Prior Art Document 1 do not have the physical structures of the lid body and the undercover fixed therein, it is difficult to ensure the rigidity of the undercover. Therefore, it is an important issue to research and develop an undercover structure that may be used for maintenance work inside a vehicle without being removed, while also ensuring aerodynamic performance and structural rigidity.

The disclosure aims to solve the above issues to achieve the objective of improving fuel efficiency, thereby contributing to energy efficiency.

### SUMMARY

The disclosure provides an undercover structure. The undercover structure includes a cover body portion formed with a notch and a lid portion covering the notch and integrally formed with the cover body portion. The lid portion is connected to the cover body portion through a first hinge portion in an openable and closable manner. The lid portion includes a flange portion. The flange portion extends to a side closer to the cover body portion than an edge of the notch. When the lid portion is in a closed state, the flange portion is overlapped with and fixed onto the cover body portion in a thickness direction of the cover body portion.

### BRIEF DESCRIPTION OF THE DRAWINGS

FIG. 1A is a three-dimensional schematic view of an undercover structure according to an embodiment of the disclosure.

FIG. 1B is a bottom schematic view of a lid portion of the undercover structure shown in FIG. 1A in an opened state.

FIG. 1C is an enlarged schematic view of the lid portion of FIG. 1B.

FIG. 1D is a schematic view of the lid portion of the undercover structure shown in FIG. 1A in a closed state.

FIG. 1E is a cross-sectional schematic view of the lid portion of FIG. 1D along a line A-A.

FIG. 2A is a schematic view of the lid portion of the undercover structure shown in FIG. 1A during forming.

FIG. 2B is a cross-sectional schematic view of the lid portion shown in FIG. 2A along a line B-B.

FIG. 3A is a schematic view of the undercover structure shown in FIG. 1A installed on a vehicle body with the lid portion in the opened state.

FIG. 3B is a cross-sectional schematic view of the undercover structure shown in FIG. 1A installed on the vehicle body with the lid portion in the closed state.

### DESCRIPTION OF THE EMBODIMENTS

The disclosure provides an undercover structure, which can improve operation quality and efficiency and has good aerodynamic performance and structural rigidity.

The disclosure provides an undercover structure. The undercover structure includes a cover body portion formed with a notch and a lid portion covering the notch and integrally formed with the cover body portion. The lid portion is connected to the cover body portion through a first hinge portion in an openable and closable manner. The lid portion includes a flange portion. The flange portion extends to a side closer to the cover body portion than an edge of the notch. When the lid portion is in a closed state, the flange portion is overlapped with and fixed onto the cover body portion in a thickness direction of the cover body portion.

In an embodiment of the disclosure, the lid portion further includes a main body portion. The main body portion is connected to the flange portion through a second hinge portion in an openable and closable manner.

In an embodiment of the disclosure, when the lid portion is in the closed state, surfaces of the cover body portion and a main body portion of the lid portion are aligned on an outer side of a vehicle.

In an embodiment of the disclosure, the cover body portion is formed with a recess recessed toward an inner side of a vehicle. When the lid portion is in the closed state, the flange portion is overlapped with the recess and fixed.

In an embodiment of the disclosure, the notch is formed into a U-shaped profile with an open end side through a first side, a second side, and a third side. The first side is formed with a first hinge portion. The second side extends from one end of the first side to an end portion of the cover body portion. The third side extends from other end of the first side to the end portion of the cover body portion. The flange portion includes a first flange portion and a second flange portion. The first flange portion extends to a side closer to the cover body portion than the second side. The second flange portion extends to a side closer to the cover body portion than the third side.

In an embodiment of the disclosure, a suspension is installed on a side surface of a tire. In a state where the undercover structure is installed on a vehicle body, the notch is formed at a position where a toe adjustment mechanism of the suspension is operable.

In an embodiment of the disclosure, a suspension installation opening is formed on the undercover structure. The notch and the suspension installation opening are continuously formed in a longitudinal direction of a vehicle body.

In an embodiment of the disclosure, the notch is respectively correspondingly formed with the suspension located on left and right of the vehicle body.

Based on the above, in the embodiment of the disclosure, the lid portion of the undercover structure is integrally connected to the cover body portion through the first hinge portion in an openable and closable manner. When the opening formed by the notch is not needed, the lid portion may be used to close the opening. Furthermore, when the lid portion is in the closed state, the flange portion may be overlapped with and fixed onto the cover body portion in the thickness direction of the cover body portion, so that the lid portion may be firmly fixed onto the cover body portion of the undercover structure, thereby not adversely affecting aerodynamic performance during driving. Furthermore, since the lid portion and the cover body portion may be integrally formed, there is no need to separately manufacture the lid portion. Furthermore, since the flange portion is overlapped with and fixed onto the cover body portion when the lid portion is closed, there is no gap between the lid portion and the cover body portion when the lid portion is closed, thereby improving aerodynamic performance and enhancing overall rigidity, so that the lid portion can be firmly held. Furthermore, even when the lid portion is moved to open the opening formed by the notch due to maintenance requirements, the lid portion remains connected to the cover body portion through the first hinge portion, so the lid portion is not lost even when the lid portion is opened for maintenance or other work.

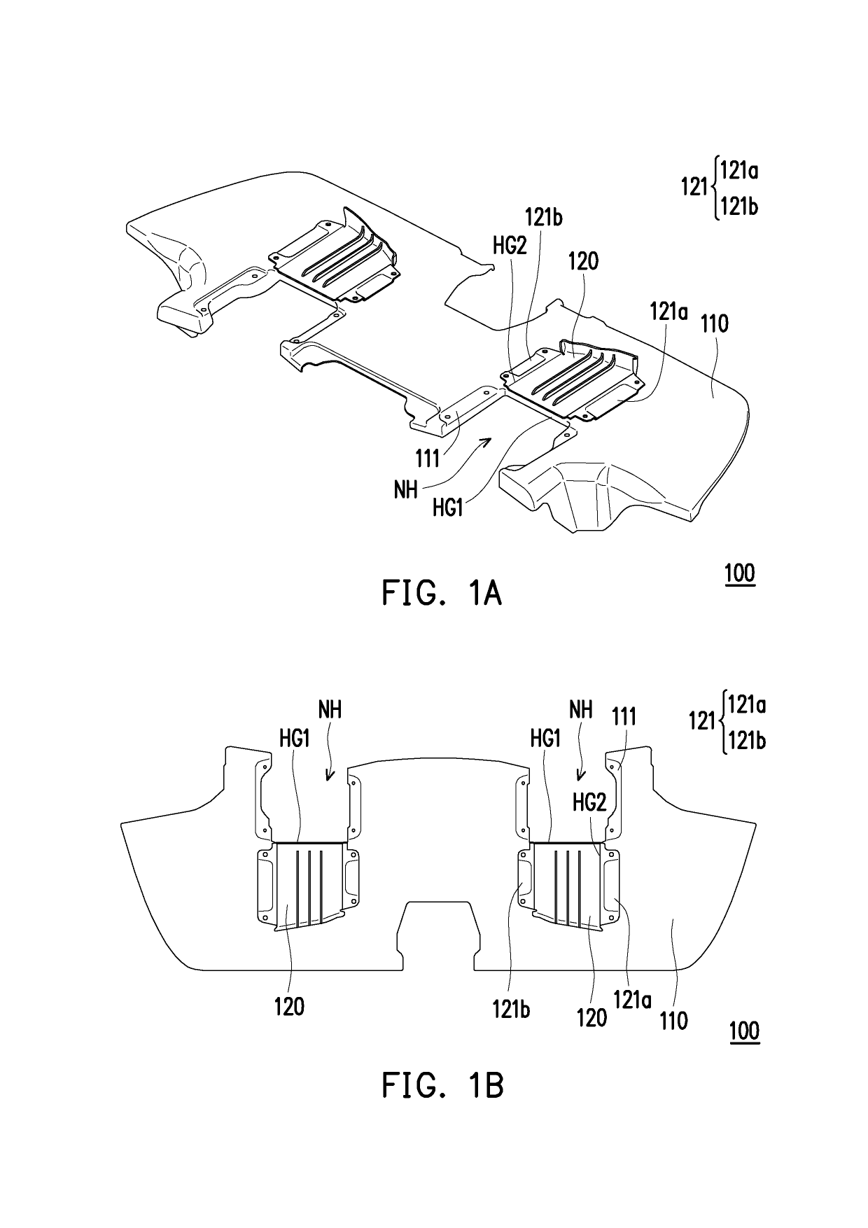

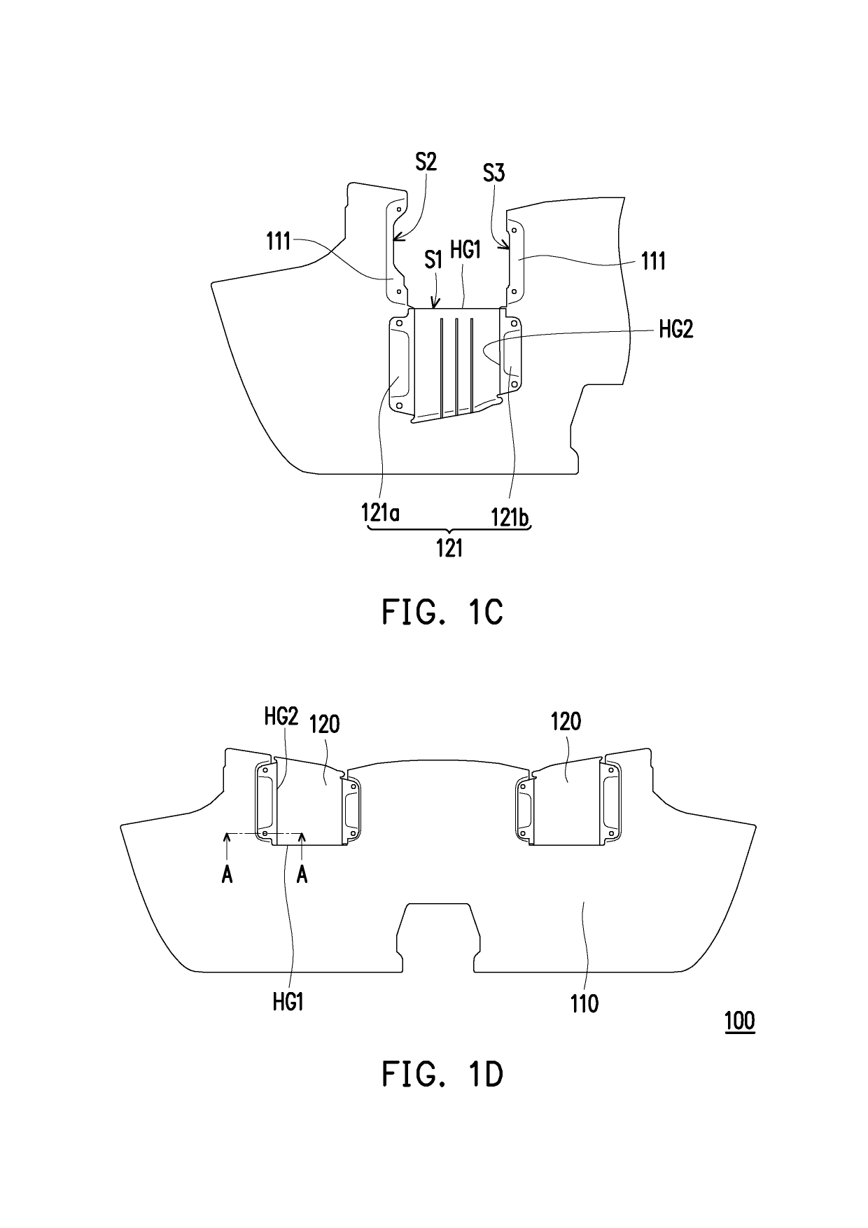

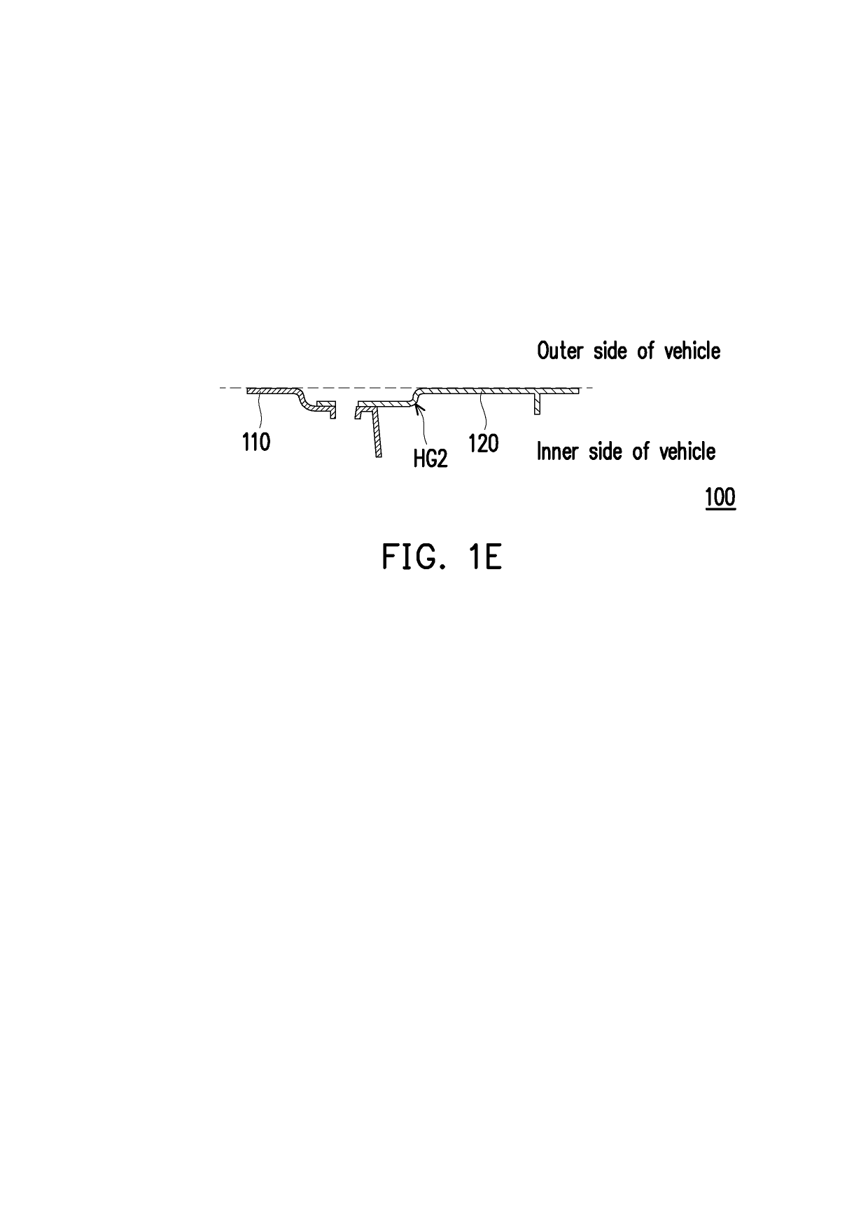

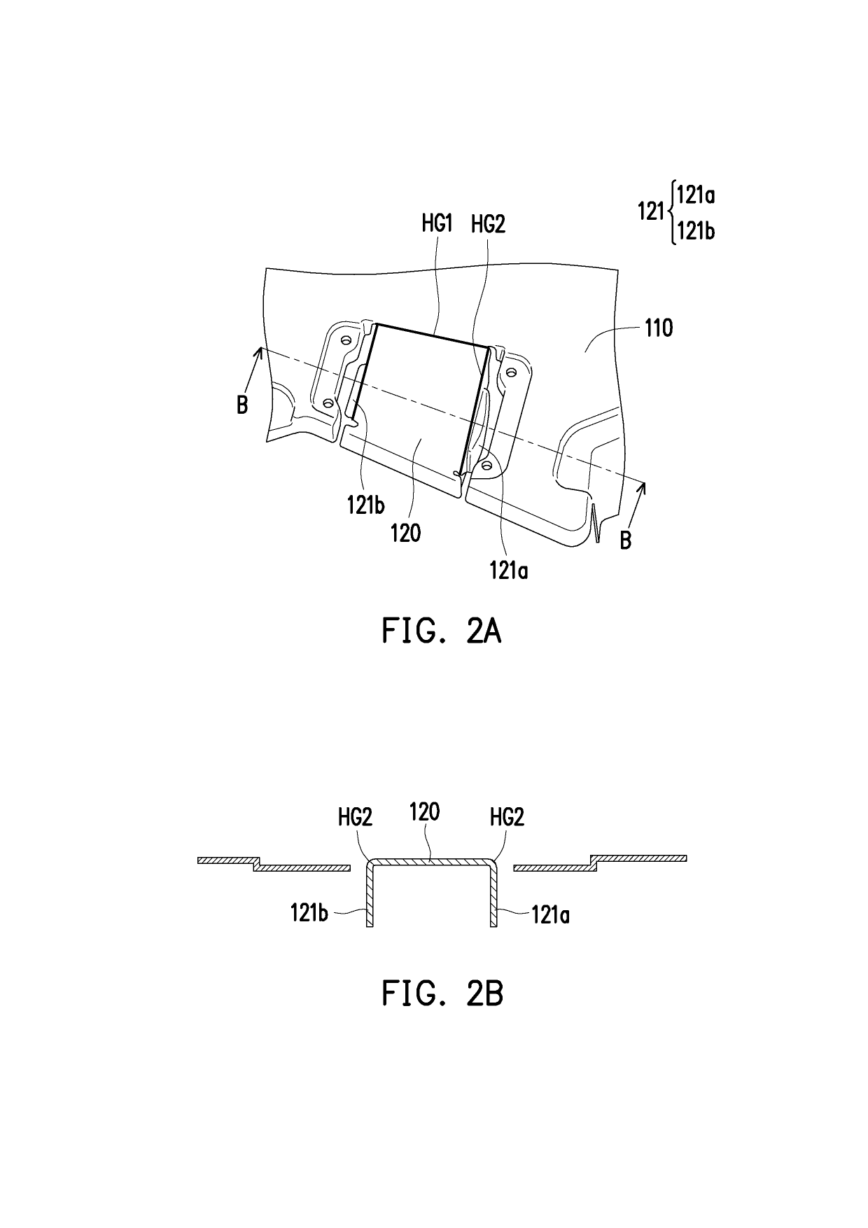

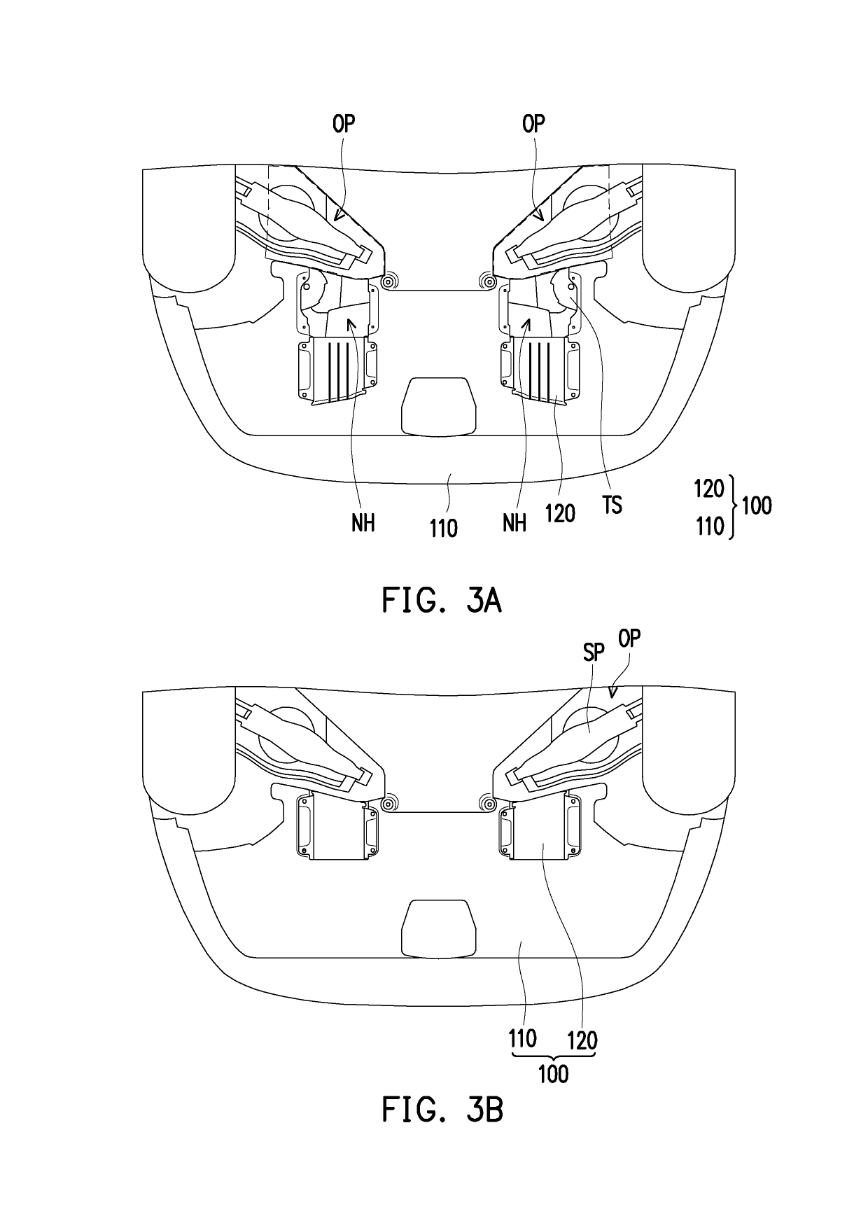

FIG. 1A is a three-dimensional schematic view of an undercover structure according to an embodiment of the disclosure. FIG. 1B is a bottom schematic view of a lid portion of the undercover structure shown in FIG. 1A in an opened state. FIG. 1C is an enlarged schematic view of the lid portion of FIG. 1B. FIG. 1D is a schematic view of the lid portion of the undercover structure shown in FIG. 1A in a closed state. FIG. 1E is a cross-sectional schematic view of the lid portion of FIG. 1D along a line A-A. FIG. 2A is a schematic view of the lid portion of the undercover structure shown in FIG. 1A during forming. FIG. 2B is a cross-sectional schematic view of the lid portion shown in FIG. 2A along a line B-B. FIG. 3A is a schematic view of the undercover structure shown in FIG. 1A installed on a vehicle body with the lid portion in the opened state. FIG. 3B is a cross-sectional schematic view of the undercover structure shown in FIG. 1A installed on the vehicle body with the lid portion in the closed state. In the embodiment, an undercover structure 100 is shown as a bottom structure located near rear tires and a suspension of a vehicle, but the disclosure is not limited thereto. In other embodiments, the undercover structure 100 may also be a bottom structure located near front tires and the suspension of the vehicle. The specific structure of the undercover structure 100 will be described below with reference to FIGS. 1 to FIG. 3B.

Specifically, as shown in FIGS. 1A to FIG. 1E, in the embodiment, the undercover structure 100 includes a cover body portion 110 and a lid portion 120, wherein the cover body portion 110 is formed with a notch NH, and the lid portion 120 covers the notch NH and is integrally formed with the cover body portion 110. Furthermore, as shown in FIGS. 1B to FIG. 1D, in the embodiment, the lid portion 120 is connected to the cover body portion 110 through a first hinge portion HG1 in an openable and closable manner, and the lid portion 120 includes a flange portion 121 and a main body portion 122, wherein the flange portion 121 extends to a side closer to the cover body portion 110 than an edge of the notch NH.

In this way, as shown in FIG. 1D, the lid portion 120 is integrally connected to the cover body portion 110 through the first hinge portion HG1 in an openable and closable manner. When the opening formed by the notch NH is not needed, the lid portion 120 may be used to close the opening. Moreover, when the lid portion 120 is in the closed state, the flange portion 121 may be overlapped with and fixed onto the cover body portion 110 in the thickness direction of the cover body portion 110, so that the lid portion 120 may be firmly fixed onto the cover body portion 110 of the undercover structure 100, thereby not adversely affecting aerodynamic performance during driving. Furthermore, since the flange portion 121 is overlapped with and fixed onto the cover body portion 110 when the lid portion 120 is closed, there is no gap between the lid portion 120 and the cover body portion 110 when the lid portion 120 is closed, thereby improving aerodynamic performance and enhancing overall rigidity, so that the lid portion 120 can be firmly held. Furthermore, even when the lid portion 120 is moved to open the opening formed by the notch NH due to maintenance requirements, the lid portion 120 remains connected to the cover body portion 110 through the first hinge portion HG1, so the lid portion 120 is not lost even when the lid portion 120 is opened for maintenance or other work.

On the other hand, as shown in FIGS. 1D and FIG. 1E, in the embodiment, the main body portion 122 and the flange portion 121 of the lid portion 120 are connected through a second hinge portion HG2 in an openable and closable manner. For example, the first hinge portion HG1 and the second hinge portion HG2 may be thin wall portions and have stretchability to serve as hinge portions. Furthermore, as shown in FIGS. 2A and FIG. 2B, in the embodiment, when forming the undercover structure 100, through the configuration of the second hinge portion HG2, the flange portion 121 of the lid portion 120 of the undercover structure 100 may be formed at an angle that does not interfere with the cover body portion 110 and is easy to form, as shown in FIG. 2B, so as to ensure formability. Furthermore, through the above configuration, the lid portion 120 and the cover body portion 110 may also be integrally formed, so there is no need to separately manufacture the lid portion 120. Furthermore, through the configuration of disposing the second hinge portion HG2 on the lid portion 120 to open or close the flange portion 121 of the lid portion 120, the flange portion 121 of the lid portion 120 may be bent to be overlapped with the cover body portion 110 when assembling the vehicle body. Therefore, aerodynamic performance can be improved without compromising formability.

In addition, please refer to FIG. 1C again. In the embodiment, the notch NH is formed into a U-shaped profile with an open end side through a first side S1, a second side S2, and a third side S3, wherein the first side S1 is formed with the first hinge portion HG1, the second side S2 extends from one end of the first side S1 to an end portion of the cover body portion 110, and the third side S3 extends from the other end of the first side S1 to the end portion of the cover body portion 110. On the other hand, the flange portion 121 includes a first flange portion 121a and a second flange portion 121b. The first flange portion 121a extends to a side closer to the cover body portion 110 than the second side S2, and the second flange portion 121b extends to a side closer to the cover body portion 110 than the third side S3. Moreover, as shown in FIG. 1C, in the embodiment, the cover body portion 110 is formed with a recess 111 recessed toward the inner side of the vehicle. Thus, as shown in FIG. 1D, when the lid portion 120 is in the closed state, the flange portion 121 may be overlapped with the recess 111 and fixed, wherein the fixing manner is, for example, fixing through fixing members such as self-tapping screws. Furthermore, the lid portion 120 may be firmly fixed onto the cover body portion 110 of the undercover structure 100 through the structure in which the notch NH with the U-shaped profile is formed with the first side S1 on which the first hinge portion HG1 is formed and the second side S2 and the third side S3 formed at two ends of the first side S1, and the first flange portion 121a and the second flange portion 121b of the flange portion 121 are respectively formed on the second side S2 and the third side S3. Furthermore, in the embodiment, through configuring the recess 111 and the flange portion 121 to have matching thicknesses, a height difference between the cover body portion 110 and the lid portion 120 at the overlapped part may be reduced, thereby further improving aerodynamic performance.

Furthermore, as shown in FIG. 1E, in the embodiment, when the lid portion 120 is in the closed state, surfaces of the cover body portion 110 and the main body portion 122 of the lid portion 120 on the outer side of the vehicle are aligned. As such, since the surfaces of the cover body portion 110 and the main body portion 122 of the lid portion 120 on the outer side of the vehicle are aligned, the aerodynamic performance of the undercover structure 100 is not deteriorated even if the undercover structure 100 is provided with ridges.

Next, as shown in FIGS. 3A and FIG. 3B, in the embodiment, a suspension installation opening OP is formed on the undercover structure 100, the notch NH and the suspension installation opening OP are continuously formed in the longitudinal direction of the vehicle body, and the notches NH are respectively correspondingly formed with suspensions SP located on the left and the right of the vehicle body. In this way, as shown in FIG. 3A, in the state where the undercover structure 100 is installed on the vehicle body and the lid portion 120 is in the opened state, the notch NH is formed at a position where a toe adjustment mechanism TS of the suspension SP installed on a side surface of a tire may be operated. Here, a toe refers to a difference value between a leading edge spacing and a trailing edge spacing of two coaxial tires or an included angle between centerlines of two tire surfaces.

In this way, as shown in FIG. 3A, since the undercover structure 100 is formed with the notches NH respectively corresponding to the suspensions SP located on the left and the right of the vehicle body and is provided with the lid portion 120, the toe adjustment mechanism TS may be operated without removing the undercover structure 100, so as to improve operation quality and efficiency. Moreover, as shown in FIG. 3B, even near the suspension SP where airflow is easily disturbed, the notch NH may be closed with the lid portion 120 after operation. Therefore, even if the notch NH serving as an operation hole is provided, aerodynamic performance is not deteriorated. In addition, since the notch NH is formed to be continuous with the suspension installation opening OP, the toe of the suspension SP may be easily adjusted. Moreover, even near the suspension SP where airflow is easily disturbed, since the lid portion 120 and the cover body portion 110 may be firmly fixed when the lid portion 120 is in the closed state, the lid portion 120 and the cover body portion 110 do not fall off due to wind pressure.

In summary, in the embodiment of the disclosure, the lid portion of the undercover structure is integrally connected to the cover body portion through the first hinge portion in an openable and closable manner. When the opening formed by the notch is not needed, the lid portion may be used to close the opening. Furthermore, when the lid portion is in the closed state, the flange portion may be overlapped with and fixed onto the cover body portion in the thickness direction of the cover body portion, so that the lid portion may be firmly fixed onto the cover body portion of the undercover structure, thereby not adversely affecting aerodynamic performance during driving. Furthermore, since the lid portion and the cover body portion may be integrally formed, there is no need to separately manufacture the lid portion. Furthermore, since the flange portion is overlapped with and fixed onto the cover body portion when the lid portion is closed, there is no gap between the lid portion and the cover body portion when the lid portion is closed, thereby improving aerodynamic performance and enhancing overall rigidity, so that the lid portion can be firmly held. Furthermore, even when the lid portion is moved to open the opening formed by the notch due to maintenance requirements, the lid portion remains connected to the cover body portion through the first hinge portion, so the lid portion is not lost even when the lid portion is opened for maintenance or other work.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. An undercover structure, comprising:
a cover body portion, formed with a notch; and
a lid portion, covering the notch and integrally formed with the cover body portion, wherein
the lid portion is connected to the cover body portion through a first hinge portion in an openable and closable manner, the lid portion comprises a flange portion, the flange portion extends to a side closer to the cover body portion than an edge of the notch,
when the lid portion is in a closed state, the flange portion is overlapped with and fixed onto the cover body portion in a thickness direction of the cover body portion.

2. The undercover structure according to claim 1, wherein the lid portion further comprises a main body portion, the main body portion is connected to the flange portion through a second hinge portion in an openable and closable manner.

3. The undercover structure according to claim 1, wherein when the lid portion is in the closed state, surfaces of the cover body portion and a main body portion of the lid portion are aligned on an outer side of a vehicle.

4. The undercover structure according to claim 1, wherein the cover body portion is formed with a recess recessed toward an inner side of a vehicle, when the lid portion is in the closed state, the flange portion is overlapped with the recess and fixed.

5. The undercover structure according to claim 1, wherein the notch is formed into a U-shaped profile with an open end side through a first side, a second side, and a third side, wherein the first side is formed with a first hinge portion, the second side extends from one end of the first side to an end portion of the cover body portion, the third side extends from other end of the first side to the end portion of the cover body portion, the flange portion comprises a first flange portion and a second flange portion, the first flange portion extends to a side closer to the cover body portion than the second side, the second flange portion extends to a side closer to the cover body portion than the third side.

6. The undercover structure according to claim 1, wherein a suspension is installed on a side surface of a tire, in a state where the undercover structure is installed on a vehicle body, the notch is formed at a position where a toe adjustment mechanism of the suspension is operable.

7. The undercover structure according to claim 1, wherein a suspension installation opening is formed on the undercover structure, the notch and the suspension installation opening are continuously formed in a longitudinal direction of a vehicle body.

8. The undercover structure according to claim 6, wherein the notch is respectively correspondingly formed with the suspension located on left and right of the vehicle body.
